(19) United States
(12) Patent Application Publication
(10) Pub. No.: US 2003/0146845 A1
(43) Pub. Date: Aug. 7, 2003

(54) Failure diagnostic apparatus for hydraulic equipment

(75) Inventor: Kunihiko Imanishi, Hirakata-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: KOMATSU LTD., Tokyo (JP)

(21) Appl. No.: 10/349,903

(22) Filed: Jan. 23, 2003

(30) Foreign Application Priority Data
Feb. 7, 2002 (JP) 2002-031562

(51) Int. Cl. G08B 21/00

(52) U.S. Cl. 340/679

(57) ABSTRACT

Failure diagnosis of hydraulic equipment related to a control of a swash plate of a swash plate type variable displacement hydraulic pump can be easily performed in a short time. For this purpose, the failure diagnostic apparatus includes a plurality of sensors which respectively detect operation characteristic values of the hydraulic equipment, a controller (40), which inputs therein the detection values detected by the plurality of sensors, and which outputs a signal of occurrence of an abnormality of hydraulic equipment which is determined as abnormal, when compares failure determination reference values previously stored according to the each hydraulic equipment, and the detection values, and determines them as abnormal, and a monitor device (41) which receives the signal of occurrence of the abnormality of the hydraulic equipment which is determined as abnormal, and gives notice by at least one of a display and a sound.

### TECHNICAL FIELD

The present invention relates to a failure diagnostic apparatus for hydraulic equipment, and particularly relates to a failure diagnostic apparatus for hydraulic equipment related to a control of a swash plate of a swash plate type variable displacement hydraulic pump in a hydraulic-driven working vehicle such as a hydraulic shovel.

### BACKGROUND ART

A hydraulic-driven working vehicle has an engine as a driving source, and a hydraulic pump operated by this engine, and for example, a hydraulic shovel has a constitution in which an actuator such as a hydraulic cylinder and a hydraulic motor is operated by pressure oil supplied from the hydraulic pump which is driven by the engine to perform various operations such as traveling, turning, and excavation. The working vehicle includes display means on which various data are displayed besides various kinds of operation means and instruments, detects operation states of various kinds of devices and an abnormality is displayed on the aforementioned display means, whereby operability, maintainability and the like are improved. As an example, the ones disclosed in Japanese Patent Laid-open No. 7-119183 and Japanese Patent Laid-open No. 9-4506 are cited.

The one disclosed in Japanese Patent Laid-open No. 7-119183 detects the engine oil pressure, engine cooling water temperature, operating oil tank internal pressure and fuel residue, then takes in the detection data every one second, and stores the newest detection data for one hour in a memory. If a failure or the like occurs to the hydraulic working machine, it displays the newest detection data on a display device to perform failure diagnosis, based on an abnormality detection signal.

The one disclosed in Japanese Patent Laid-open No. 9-4506 connects an engine rotation sensor and a control rack position sensor of an all speed governor to an abnormality determining section of a controller. When a detection value of the rack position sensor at the time of a detection value of the engine rotation sensor being zero is different from an initial control rack position, it is determined that the rotation sensor is abnormal, and sends a notice to an operator by warning means. Thereby, determination of a spot where a failure occurs and repair are performed quickly, thus improving availability of construction equipment.

Incidentally, in order to use engine horse power effectively and reduce hydraulic pressure loss, for example, a swash plate type variable displacement hydraulic pump is used for a hydraulic shovel and a swash plate control system for the pump is included, whereby an angle of the swash plate of the hydraulic pump is controlled according to the engine speed and operation amount of the operation valve, and the discharge amount of the pump is controlled.

One example of the above-described pump swash plate control system will be explained below as a third example of the prior art. FIG. 5 is a schematic system diagram showing the swash plate control system. In FIG. 5, a governor lever (not shown) of a governor 2, which is provided at an engine 1, is operated by a throttle lever 3. The engine 1 is provided with an engine rotation sensor 4, and the governor 2 is provided with a throttle sensor 5 which detects an operation angle of the governor lever. A swash plate type variable displacement first pump 10 and second pump 20 are connected to the engine 1 to be driven, and the first pump 10 is connected to a first actuator 12 via a first operation valve 11. A first servo valve 13, which controls a swash plate angle, is provided at the first pump 10, and the first servo valve 13 is connected to a first NC valve 14. The first operation valve 11 and the first NC valve 14 are connected via a first jet sensor 15.

The second pump 20 is connected to a second actuator 22 via a second operation valve 21. A second servo valve 23, which controls a swash plate angle, is provided at the second pump 20, and the second servo valve 23 is connected to a second NC valve 24. The second operation valve 21 and the second NC valve 24 are connected via a second jet sensor 25. Further, the first operation valve 11 and the second operation valve 21 are connected to a pressure proportional control valve 30, and the first and second operation valves 11 and 21 are operated proportionally to an operation amount of the pressure proportional control valve 30, and supply pressure oil to the first and the second actuators 12 and 22.

The first NC valve 14 and the second NC valve 24 are connected to a TVC valve (torque variable control valve) 31. The TVC valve 31 is connected to a control pump 33, a first discharge circuit 10a of the first pump 10 and a second discharge circuit 20a of the second pump 20. The first discharge circuit 10a of the first pump 10 is provided with a first pump discharge pressure sensor 16, and the second discharge circuit 20a of the second pump 20 is provided with a second pump discharge pressure sensor 26. A controller 40 is connected to the engine rotation sensor 4, the throttle sensor 5, a mode changeover switch 6 which changes an operation mode, the first pump discharge pressure sensor 16, the second pump discharge pressure sensor 26, a solenoid 32 attached to the TVC valve 31, and a monitor indicator 45. The controller 40 inputs therein a detection signal from each of the above-described sensors, and outputs predetermined signals to the solenoid 32 and the monitor indicator 45.

FIG. 6 is a schematic structural drawing of a flow control section of a pump swash plate control system shown in FIG. 5. In FIG. 6, the discharge circuits of the first and the second pumps 10 and 20 are connected to the operation valve 11, and are connected to the NC valve 14 via a restrictor 50 of the jet sensor 15. A piston 51, which is located at an upper part of the NC valve 14, is biased downward in the drawing by the pressure Pt at a downstream side of the restrictor 50 of the jet sensor 15. A spool 52, which is located under the piston 51, is biased upward in the drawing by a spring 53, and its upper end portion abuts to a lower end portion of the piston 51. A lower end portion of the spool 52 is connected to an oil tank 54 via the restrictor 50, and its pressure is Pd. The jet sensor 15 detects the flow of returning oil to the oil tank 54, which passes through the operation valve 11, to set the pressures Pt and Pd of the NC valve 14. The discharge circuit of the control pump 33 is connected to the servo valve 13 from the TVC valve 31 via the spool 52 of the NC valve 14. The pressure between the TVC valve 31 and the NC valve 14 is assumed to be Pec, and the pressure between the NC valve 14 and the servo valve 13 is assumed to be Pecn. Reference numeral 55 denotes a servo piston.

Next, a general outline of an operation of a flow control will be explained.

(1) Engine Rotation and Hydraulic Sensing Control

This is the function of always keeping the engine speed at a fixed speed even if a load is changed to utilize horse power of the engine effectively. In FIG. 5, the controller 40 inputs a signal from the engine rotation sensor 4 and the throttle sensor 5, and compares the engine set speed previously stored and an actual engine speed. When a difference occurs between both of them, the controller 40 outputs a predetermined control current signal to the solenoid 32 of the TVC valve 31. The TVC valve 31 changes output pressure which is supplied to the first and the second servo valves 13 and 23 via the first and the second NC valves 14 and 24 in proportion to the above-described control current signal. As a result, the first and the second servo valves 13 and 23 change the respective swash plate angles of the first and the second pumps 10 and 20 to control the pump capacities. For example, when the load on the fist and the second actuators 12 and 22 become large during operation and the pump discharge pressure becomes high, the engine speed is reduced.

In this situation, the controller 40 outputs the aforementioned control current signal based on the detection signal of the engine rotation sensor 4 which is inputted in the controller 40. The TVC valve 31 reduces the output pressure to the first and the second servo valves 13 and 23, reduces the respective swash plate angles of the first and the second pumps 10 and 20, restricts the pump discharge amount to reduce the pump absorption torque, and reduces the load on the engine to restore the engine speed. Consequently, the operation can be performed without reducing the engine speed (reducing the operation amount), and therefore the load on the engine can be reduced to reduce fuel consumption. The present control is performed, for example, when the operation mode, which is selected by the mode changeover switch 6, is a light load mode.

(2) Flow Control

This is the function of controlling the swash plates of the first and the second pumps 10 and 20 according to the operation amounts of the first and the second valves 11 and 21 to control the discharge amount to enhance operability and reduce hydraulic pressure loss. In FIG. 6, when the operation valve 11 is neutral, the jet sensor pressure difference (Pt−Pd) becomes the largest, and the force with which the jet sensor output pressure Pt presses the piston 51 becomes larger than the total of the force of the spring 53 and the force with which the jet sensor output pressure Pd presses the lower end of the spool 52. Consequently, the spool 52 is pressed downward, and therefore the opening area of the circuit which connects the servo valve 13 of the NC valve 14 and the oil tank 54 becomes large. As a result, the output pressure Pecn of the NC valve 14 becomes the lowest, and the discharge amounts of the first and the second pumps 10 and 20 become the smallest, thus reducing the hydraulic pressure loss when the operation valve 11 is neutral.

Next, when the operation valve 11 is moved from the neutral position, the jet sensor pressure difference (Pt−Pd) is reduced according to the stroke amount, and therefore the spool 52 is pressed upward. Accordingly, the opening area of the circuit of the NC valve 14, which connects the servo valve 13 and the TVC valve 31 becomes large, and the output pressure Pecn of the NC valve 14 is increased, thus increasing the discharge amount of the first pump 10. The control of the discharge amount of the second pump 20 when the second operation valve 21 is operated is the same as described above. According to the above, the discharge amounts of the corresponding first and the second pumps 10 and 20 are increased or decreased corresponding to the operation amounts of the first and the second operation valves 11 and 21, which increases and decreases in proportion to the operation amount of the pressure proportional control valve 30, whereby a waste flow occurring at the time of a fine control is reduced and fine control performance is improved.

The monitor indicator 45 displays, for example, normal operation information such as engine water temperature and engine oil, working information such as fuel consumption amount, trouble information such as clogging of an air cleaner, operation switch information of the working mode and the like. A service technician performs a specified operation such as, for example, concealed switch operation (which is not notified to the operator), and thereby the engine speed, pump pressure and the like can be displayed on the monitor indicator 45. In this situation, when a failure occurs to the swash place control system of the pump, the service technician follows the failure diagnosis manual, performs, for example, special operation exclusive for service and a specified operation by the switch or the like, and makes the engine speed and the pump pressure displayed on the monitor indicator 45 one by one in sequence. Meanwhile, as for the NC valve output pressure, the TVC valve output pressure, the jet sensor pressure difference and the like related to the swash plate control of the pumps, actual measurement is performed using additional measurement devices, and based on the actual measurement values, failure diagnosis is performed.

However, the above-describe constitution has the following problems. In the ones disclosed in Japanese Patent Laid-open No. 7-119183 and Japanese Patent Laid-open No. 9-4506, information related to the engine is detected to perform failure diagnosis of the hydraulic system caused by the engine trouble. Accordingly, a large effect cannot be expected in the failure diagnosis of the hydraulic devices (for example, the TVC valve 31, the NC valves 14 and 24, the jet sensors 15 and 25, and the like in FIG. 5 and FIG. 6) related to the control of the swash plates of the swash plate type variable displacement hydraulic pump as described above, and the fact is that much time is required to determine the faulty hydraulic devices.

In the swash plate control apparatus of the swash plate type variable displacement hydraulic pump, which is shown in the third example, the number of the hydraulic devices (the TVC valve 31, the NC valves 14 and 24, the jet sensors 15 and 25 and the like) related to the swash plate control is large. In addition, operation characteristic values of these devices influence on each other in various conditions which differ according to the control states, and therefore much skill is required to determine a spot where an abnormal condition or a failure occurs. Conventionally, a service technician performs a special operation exclusive for service or operates a special switch according to the failure diagnosis manual after an abnormality and a failure occur, whereby the operation characteristic value of each hydraulic device, which is necessary for diagnosis, is displayed on the monitor indicator 45 one by one in sequence. Since the operation characteristic values of the hydraulic devices related to the above-described swash plate control are not displayed on the monitor indicator 45, the characteristic values are measured in sequence with separate measurement devices, and failure diagnosis has to be performed based on these results. Accordingly, much time is taken to determine abnormal or faulty hydraulic devices, operability at the time of diagnosis is not favorable.

### SUMMARY OF THE INVENTION

The present invention is made in view of the above-described problems, and has its object to provide a failure diagnostic apparatus for hydraulic equipment, which can easily perform failure diagnosis of hydraulic equipment related to a control of a swash plate of a swash plate type variable displacement hydraulic pump in a short time.

In order to attain the above-described object, a first aspect of a failure diagnostic apparatus for hydraulic equipment according to the present invention is a failure diagnostic apparatus, which diagnoses a failure of hydraulic equipment related to a control of a swash plate of a swash plate type variable displacement hydraulic pump included in a hydraulic-driven working vehicle, and includes a plurality of sensors which respectively detect operation characteristic values of the hydraulic equipment, and a monitor device which inputs therein detection values detected by the plurality of sensors, and arranges and displays them on one screen.

According to the above first constitution, the operation characteristic values showing the operation state of the hydraulic equipment related to the swash plate control of the swash plate type variable displacement hydraulic pump are detected, and the detection values are arranged and displayed on one screen. Conventionally, a service technician individually displays each of detection values of the engine speed, pump pressure and the like one by one by a predetermined operation (for example, by special operation, a switch and the like exclusive for service), or measures the operation characteristic values of the hydraulic equipment related to the swash plate control such as, for example, NC valve output pressure, TVC valve (torque variable control valve) output pressure, jet sensor pressure difference and the like by predetermined measurement instruments. On the other hand, in the above first constitution, these detection values of a plurality of operation characteristic values related to each other can be seen on the same screen at the same time. Accordingly, the operator can see a plurality of characteristic values by a simple operation and small number of operation times and compare them with the failure determination reference values, and can easily determine presence or absence of abnormality. When a failure occurs, the operator and service technician can easily perform failure diagnosis in a short time.

Further, in the failure diagnostic apparatus for the hydraulic equipment, a controller, which inputs therein the detection values detected by the plurality of sensors, and which outputs a signal of occurrence of an abnormality of hydraulic equipment which is determined as abnormal, when compares failure determination reference values previously stored according to the each hydraulic equipment, and the detection values, and determines them abnormal, and the monitor device receives the signal of occurrence of the abnormality of the hydraulic equipment which is determined as abnormal, and gives notice by at least one of a display and a sound.

According to the above constitution, the controller inputs therein the detection values of the operation characteristic values, and when it compares these detection values and the previously stored failure determination reference values and determines them as abnormal, the abnormal spot such as the name of the hydraulic device to which an abnormality occurs is notified with a display, a sound or the like by the monitor device. Consequently, the operator can easily find out the spot to which the abnormality occurs, and the operator can diagnose the tendency of occurrence of an abnormality by automatic failure diagnosis before a concrete problem (failure) occurs, and identify the hydraulic device having the abnormality early, thus making it never happen that operation is performed in an abnormal condition to cause reduction in operation efficiency and increase in fuel consumption.

Further, in the failure diagnostic apparatus of the hydraulic equipment, the operation characteristic values of the hydraulic apparatus may include at least any one of NC valve output pressure, TVC valve output pressure, hydraulic pump discharge pressure, and jet sensor output pressure difference.

According to the above constitution, the detection values of the characteristic values of the hydraulic equipment includes at least any one of the output pressure of the NC valve, the output pressure of the TVC valve, the discharge pressure of the hydraulic pump and the output pressure difference of the jet sensor, which influence the control of the swash plate the most, and this is displayed on the same screen with the other detection values. These detection values are measured individually only at the time of failure diagnosis of the hydraulic equipment related to the swash plate control, and therefore they are not displayed on the monitor screen, but this constitution makes it possible to monitor them on the same screen at the same time. Accordingly, the abnormal spot of the hydraulic equipment and the like causing a failure related to the swash plate control can be properly identified, and operability at the time of failure diagnosis can be improved.

A second aspect of a failure diagnostic apparatus of hydraulic equipment according to the present invention is a failure diagnostic apparatus for hydraulic equipment related to a control of a swash plate of a swash plate type variable displacement hydraulic pump included in a hydraulic-driven working vehicle, and includes a plurality of sensors which respectively detect operation characteristic values of the hydraulic equipment, a controller, which inputs therein the detection values detected by the plurality of sensors, and which outputs a signal of occurrence of an abnormality of hydraulic equipment which is determined as abnormal, when compares failure determination reference values previously stored according to the each hydraulic equipment, and the detection values, and determines them as abnormal, and a monitor device which receives the signal of occurrence of the abnormality of the hydraulic equipment which is determined as abnormal, and gives notice by at least one of a display and a sound.

According to the above second constitution, the controller inputs therein the detection values of the operation characteristic values of the hydraulic equipment related to the control of the swash plate of the swash plate type variable displacement hydraulic pump, and makes a notification of the abnormal spot such as the name of the hydraulic equipment to which the abnormality occurs with a display, a sound or the like by the monitor device. Consequently, the operator can easily find out the spot to which the abnormality occurs. By always monitoring and automatically performing failure diagnosis, an abnormal spot can be found early. Conventionally, the operator and the service technician measure the characteristic values of each hydraulic equipment in sequence according to a failure diagnosis manual to perform failure diagnosis after a problem (failure) of the operation efficiency being reduced or the fuel consumption amount being increased occurs. On the other hand, according to the above second constitution, the tendency of the occurrence of abnormality is automatically diagnosed before a concrete problem (failure) occurs, and abnormal hydraulic equipment can be identified early, thus never making it happen that an operation is continued in an abnormal condition to cause reduction in operation efficiency, increase in fuel consumption or the like.

### BRIEF DESCRIPTION OF THE DRAWINGS

FIG. 1 is a system diagram of a failure diagnostic apparatus of a swash plate type variable displacement hydraulic pump according to an embodiment of the present invention;

FIG. 2 is an example of a real time monitor screen of the failure diagnostic apparatus according to the embodiment;

FIG. 3 is an example of a monitor screen of the failure diagnostic apparatus according to the embodiment;

FIG. 4 is a flowchart example at the time of automatic failure diagnosis of the failure diagnostic apparatus according to another example of the embodiment;

FIG. 5 is a system diagram of a swash plate control system of a conventional variable displacement hydraulic pump; and

FIG. 6 is an explanatory view of a flow control section of the swash plate control system in FIG. 5.

### BEST MODE FOR CARRYING OUT THE INVENTION

A preferred embodiment of the present invention will be described in detail below with reference to the drawings.

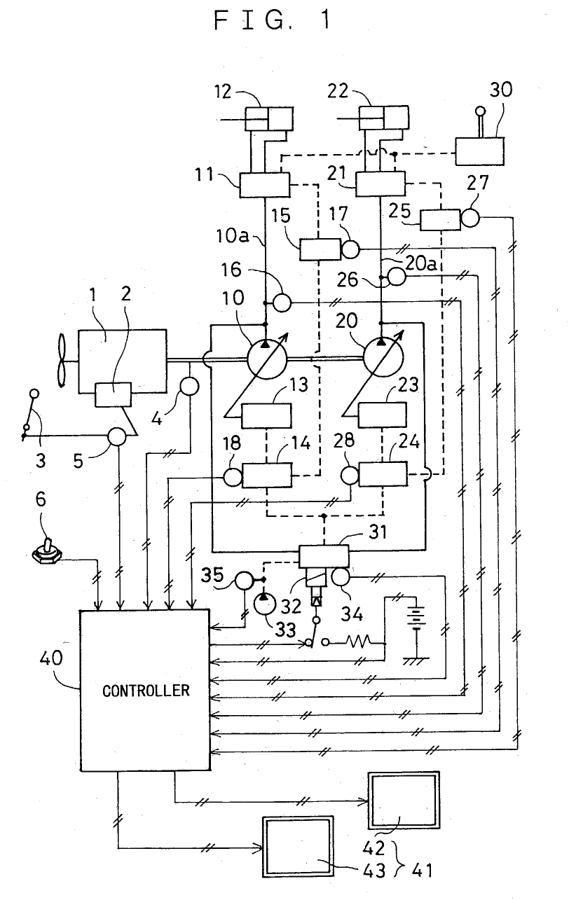

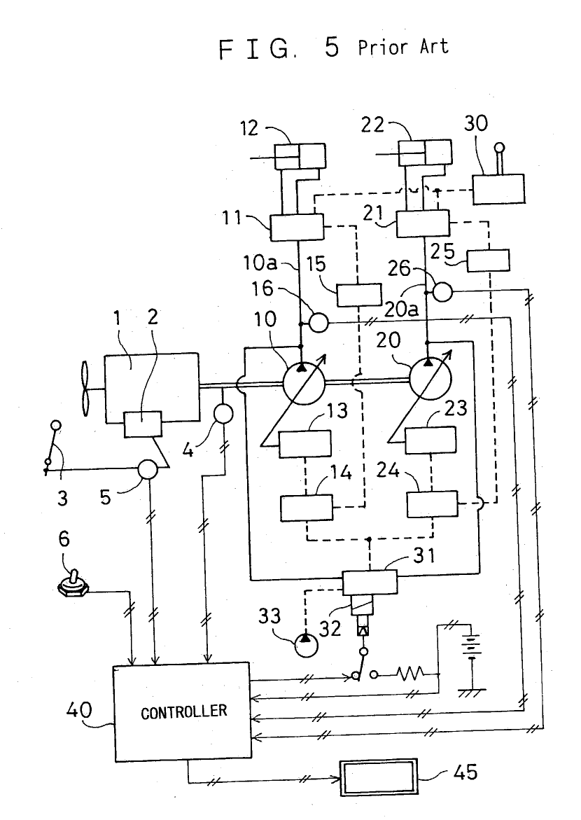

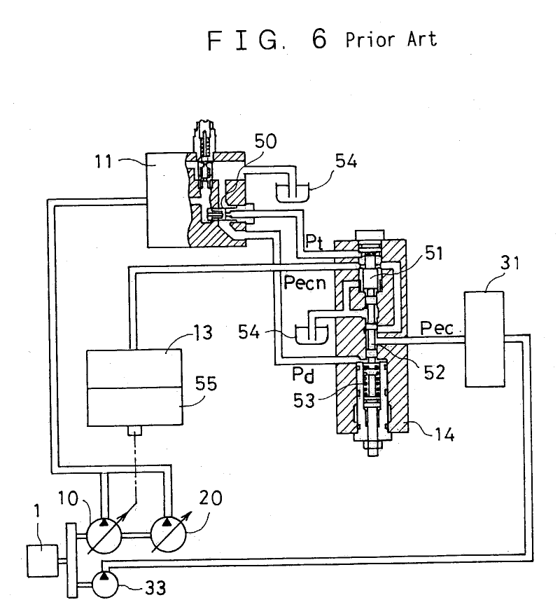

FIG. 1 is a system diagram of a failure diagnostic apparatus of a swash plate type variable displacement hydraulic pump. The components with the same constitution as explained in FIG. 5 are given the same reference numerals and symbols and the explanation thereof will be omitted below, and only different parts will be explained. In FIG. 1, each kind of sensor which detects an operation characteristic value of each hydraulic equipment related to a swash plate control is provided. Namely, a first jet sensor 15 and a second jet sensor 25 are provided with a first jet pressure difference sensor 17 and a second jet pressure difference sensor 27, respectively, which detect jet sensor output pressure difference (corresponds to Pt−Pd in FIG. 6). A first NC valve 14 and a second NC valve 24 are provided with a first NC pressure sensor 18 and a second NC pressure sensor 28 respectively, which detect output pressures of the NC valves.

Further, a TVC valve 31 is provided with a TVC pressure sensor 34 which detects output pressure of the TVC valve, and a discharge circuit of a control pump 33 is provided with a control pressure sensor 35 which detects discharge pressure, respectively. Each of these sensors inputs its detection value into the controller 40. These sensors which detect the operation characteristic values of the hydraulic devices related to the swash plate control may be always attached inside the control circuit, or may be attached to be detachable and attachable with a connector for an electrical signal, a coupler for hydraulic equipment and the like so that they can be easily attached when diagnosis is necessary.

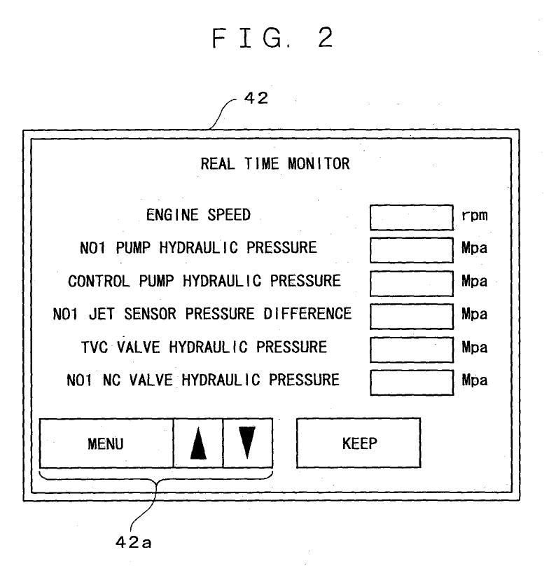

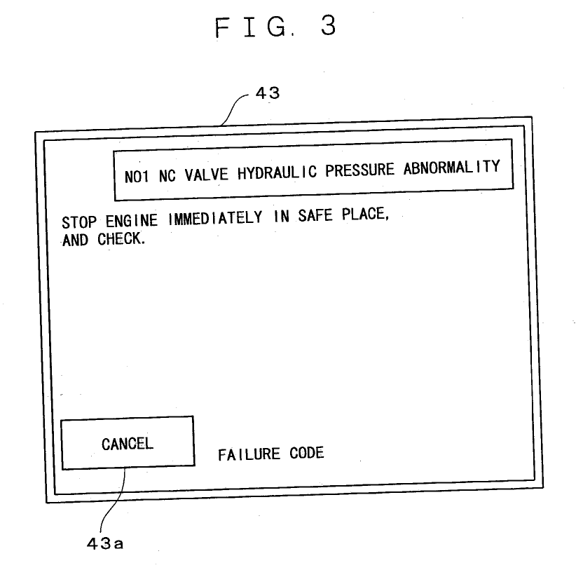

A monitor device 41 including a real time monitor indicator 42 and a monitor indicator 43 is connected to the controller 40. As shown in FIG. 2, the real time monitor indicator 42 arranges a plurality of sensor detection values to make it possible to display them, and is constituted by a graphic screen indicator such as a liquid crystal indicator and a plasma indicator, and/or a character indicator capable of displaying a plurality of data at the same time. In this embodiment, a constitution example with a graphic screen indicator is cited. The monitor indicator 43 is capable of displaying normal driving information such as the aforementioned engine water temperature and engine oil temperature, operation information such as a fuel consumption amount and operation time, trouble information such as air cleaner clogging and an abnormal NC valve hydraulic pressure, operation switch information of an operation mode, and the like. The monitor indicator 43 is also constituted by the graphic screen indicator and/or a character indicator, and an example constituted by the graphic screen indicator as shown in FIG. 3 is cited in this embodiment.

The monitor device 41 has a screen selection switch 42a to select and display various kinds of real time monitor screens of the real time monitor indicator 42, and each kind of operation switch 43a to select and display various kinds of monitor screens of the monitor indicator 43, or reset the display content. In this embodiment, as shown in FIG. 2 and FIG. 3, programmable indicators with touch panels each with a transparent touch switch sheet being attached on a front surface of a graphic screen indicator are used for the real time monitor indicator 42 and the monitor indicator 43. The screen selection switch 42a and each kind of operation switch 43a are constituted by the transparent touch switches, but the present invention is not limited to this.

Next, an operation will be explained. Each of sensor detection signals from the engine rotation sensor 4, the throttle sensor 5, the first and the second jet sensors 15 and 25, the fist and the second pump discharge pressure sensors 16 and 26, the first and the second jet pressure difference sensors 17 and 27, the first and the second NC pressure sensors 18 and 28, the TVC sensor 34, the control pump pressure sensor 35 and the like are inputted into the controller 40. The controller 40 outputs each of the monitor data based on the inputted sensor detection signals to the real time monitor indicator 42. When the operator selects a desired screen with the screen selection switch 42a, the real time monitor indicator 42 arranges and displays a plurality of present monitor data corresponding to the selected screen.

Here, an example of the real time monitor screen, which displays the characteristic values of the hydraulic devices related to the swash plate control, of the real time indicator 42 is shown in FIG. 2. In FIG. 2, the respective monitor data of engine speed, NO1 pump hydraulic pressure, control pump hydraulic pressure, NO1 jet sensor pressure difference, TVC valve hydraulic pressure and NO1 NC valve hydraulic pressure are arranged and displayed on the same screen. By selecting and switching the screen, the data of the NO2 pump hydraulic pressure, NO2 jet sensor pressure difference, NO2 NC valve hydraulic pressure and the like are arranged and displayed on the same screen. The TVC valve hydraulic pressure is displayed in a pressure value in the drawing, but it may be displayed in, for example, the TVC current value, which is proportional to hydraulic pressure.

Next, the operator confirms the characteristic value of the hydraulic equipment related to the swash plate control, which is displayed on the above-described real time monitor screen. Meanwhile, the operators and service technicians carry failure diagnosis manuals, and in this failure diagnosis manual, the measurement condition and the failure determination reference value under the condition are described according to each of the hydraulic devices related to the swash plate control. The failure determination reference value is a reference value to determine presence or absence of occurrence of an abnormality to each of the device, and is made a normal value of the operation characteristic value during operation according to each measurement condition, for example. The operator and the service technician compare the above-described confirmed characteristic value with the failure determination reference value under each measurement condition, and from the results of the comparison, they determine presence or absence of an abnormal condition of each of the hydraulic devices.

As an example of the above-described measurement condition, in the case of diagnosis of the output pressure of the first and the second NC valves, 1) engine speed, 2) operation oil temperature, 3) whether the total operation lever is neutral or not, 4) whether it is the time of idle traveling, and the like are set. The monitor data related to them are arranged and displayed on the real time monitor screen.

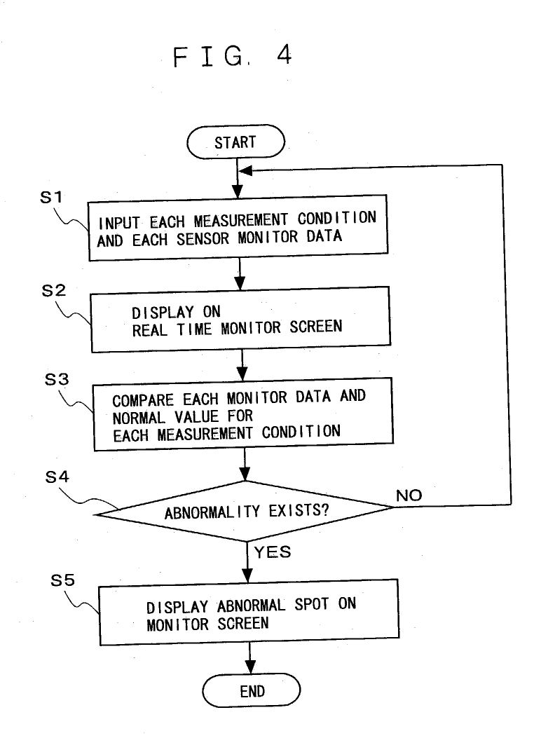

Next, as another example of the embodiment, the case in which the controller 40 automatically performs failure diagnosis as described above will be explained with reference to FIG. 4. FIG. 4 is a flowchart example of processing of automatic failure diagnosis. The controller 40 previously stores the measurement condition and the failure determination reference value (normal value and the like) under the condition according to each device for which failure diagnosis is performed, for example, according to each hydraulic device related to the swash plate control. In FIG. 4, at first in step S1, while the operator is operating the equipment during an operation, the controller 40 inputs therein the information related to each measurement condition from the corresponding condition detection sensors (for example, the operation lever neutral position detection sensor, the engine operation oil temperature sensor and the like) in real time. With this input, the controller 40 inputs therein each monitor data related to each hydraulic device (for example, the first and the second pump discharge pressure, the output pressure difference of the first and the second jet sensors, the output pressure of the first and the second NC valves, and the TVC pressure) in real time.

In step S2, each inputted monitor data is outputted to the real time monitor indicator 42. Next, in step S3, the controller 40 compares the measurement condition signals inputted from the above-described condition detection sensor and the monitor data related to each of the hydraulic devices with the aforementioned measurement condition and failure determination reference value which are previously stored. When the aforementioned comparison result is determined as abnormal in step 4, the abnormal spot (the name of the hydraulic device in an abnormal condition and the like) is displayed on the monitor indicator 43.

FIG. 3 shows an example of the monitor screen displaying an abnormality of the hydraulic equipment related to the swash plate control, on the monitor indicator 43. As shown in FIG. 3, an error message telling, for example, what valve has an abnormalty is displayed on the monitor screen. The display content is not limited to an error message, but it may be displayed in an error code and the like. When an abnormality of the hydraulic equipment and the like is displayed on the monitor screen, the operator stops the engine according to the instruction content on the monitor screen and checks the corresponding abnormal spot. When the abnormal device cannot be repaired, the content of the abnormality is reported to a service technician. The service technician confirms the characteristic value related to the content of the abnormal condition, for example, the characteristic value of the operation condition of each hydraulic device related to the swash plate control from the real time monitor screen at the same time on the same screen, and determines the abnormal spot of the hydraulic device according to the display of the abnormality on the above-described monitor screen and repairs it. When abnormal information of a plurality of hydraulic devices are displayed on the monitor screen, the failure spots are determined in order from the hydraulic device at the upstream side of the system, and thereby a failure can be effectively diagnosed.

Since the failure diagnostic apparatus of the hydraulic equipment of the present invention has the constitution as described above, the operation characteristic values of a plurality of related hydraulic devices, which are arranged and displayed on the same real time monitor, can be confirmed at the same time in a short time (namely, with small number of operation times), and the operability at the time of failure diagnosis can be improved. Since the abnormal or faulty hydraulic device can be easily identified, it can be repaired in a short time. Further, the operator can confirm the operation characteristic value of the hydraulic equipment from the real time monitor screen at a glance, and easily find the abnormal spot, and therefore reduction in operation efficiency or increase in fuel consumption by continuing the operation of the working vehicle in an abnormal condition are not caused.

The controller automatically performs failure diagnosis of the hydraulic equipment by comparing each measurement condition signal inputted in real time during operation and monitor data of each hydraulic device with the failure determination reference values corresponding to each measurement condition, and therefore an abnormal spot can be found out early. Consequently, it does not happen that the operation is continued with the working vehicle in an abnormal condition to cause reduction in operation efficiency and increase in fuel consumption. The sensor for detecting the operation characteristic value of the above-described hydraulic devices is constituted by a connector, coupler and the like to be attachable and detachable, and the sensor is connected and attached to the predetermined spot of the control circuit when diagnosis is necessary, whereby signal stress at the time of detection is not always exerted on the sensor, and the life of the sensor can be elongated. Further, since it can be also used for the other working vehicles in common as a sensor unit, the production cost and maintenance cost of the vehicle can be reduced.

In the above-described embodiment, the explanation is made with the constitution in which the monitor device has the monitor indicator and the real time monitor indicator separately, but the functions of both indicators can be constituted in one indicator. An example in which at least any one of the pump hydraulic pressure, the jet sensor pressure difference, the TVC hydraulic pressure and the NC valve hydraulic pressure is displayed on the real time monitor indicator is shown, but a desired one may be selected from them and displayed. Further, the monitor device is not limited to performing of display of an abnormality on the monitor screen when the abnormality occurs, but it may inform the abnormality by display of the abnormality and/or a sound (including an audible alarm).

What is claimed is:

1. A failure diagnostic apparatus for hydraulic equipment, which diagnoses a failure of hydraulic equipment related to a control of a swash plate of a swash plate type variable displacement hydraulic pump included in a hydraulic-driven working vehicle, comprising:
a plurality of sensors which respectively detect operation characteristic values of said hydraulic equipment; and
a monitor device which inputs therein detection values detected by said plurality of sensors, and arranges and displays them on one screen.

2. The failure diagnostic apparatus of the hydraulic equipment according to claim 1, further comprising:
a controller, which inputs therein the detection values detected by said plurality of sensors, and which outputs a signal of occurrence of an abnormality of hydraulic equipment which is determined as abnormal, when compares failure determination reference values previously stored according to said each hydraulic equipment, and said detection values, and determines them as abnormal,
wherein said monitor device receives the signal of occurrence of the abnormality of said hydraulic equipment which is determined as abnormal, and gives notice by at least one of a display and a sound.

3. The failure diagnostic apparatus of the hydraulic equipment according to claim 1,
wherein the operation characteristic values of said hydraulic apparatus include at least any one of NC valve output pressure, TVC valve output pressure, hydraulic pump discharge pressure, and jet sensor output pressure difference.

4. A failure diagnostic apparatus for hydraulic equipment related to a control of a swash plate of a swash plate type variable displacement hydraulic pump included in a hydraulic-driven working vehicle, comprising:
a plurality of sensors which respectively detect operation characteristic values of said hydraulic equipment;
a controller, which inputs therein the detection values detected by said plurality of sensors, and which outputs a signal of occurrence of an abnormality of hydraulic equipment which is determined as abnormal, when compares failure determination reference values previously stored according to said each hydraulic equipment, and said detection values, and determines them as abnormal; and
a monitor device which receives the signal of occurrence of the abnormality of said hydraulic equipment which is determined as abnormal, and gives notice by at least one of a display and a sound.

5. The failure diagnostic apparatus of the hydraulic equipment according to claim 4,
wherein the operation characteristic values of said hydraulic equipment include at least any one of NC valve output pressure, TVC valve output pressure, hydraulic pump discharge pressure, and jet sensor output pressure difference.
